(19) United States
(12) Patent Application Publication
(10) Pub. No.: US 2009/0088195 A1
(43) Pub. Date: Apr. 2, 2009

(54) METHOD AND APPARATUS FOR SIGNALING OF SCHEDULING INFORMATION

(75) Inventors: Claudio Rosa, Randers (NV) (DK); Benoist P. Sebire, Tokyo (JP); Tsuyoshi Kashima, Tokyo (JP)

Correspondence Address: DITTHAVONG MORI & STEINER, P.C., 918 Prince St., Alexandria, VA, 22314, US

(73) Assignee: Nokia Corporation, Helsinki (FI)

(21) Appl. No.: 12/239,151

(22) Filed: Sep. 26, 2008

Related U.S. Application Data
(60) Provisional application No. 60/976,250, filed on Sep. 28, 2007.

(51) Int. Cl. H04W 4/00; H04L 12/56

(52) U.S. Cl. 455/507; 370/389

(57) ABSTRACT

An approach is provided for signaling of scheduling information. A determination of one or more parameters for inclusion as scheduling information is made. A message containing the scheduling information in a header field is generated, wherein the one or more parameters include at least one of buffer status information, power headroom information, or a combination thereof.

### RELATED APPLICATIONS

This application claims the benefit of the earlier filing date under 35 U.S.C. §119(e) of U.S. Provisional Application Ser. No. 60/976,250 filed Sep. 28, 2008, entitled “Method and Apparatus for Signaling of Scheduling Information,” the entirety of which is incorporated herein by reference.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves control signaling to ensure accurate and efficient transmission of data.

### SOME EXEMPLARY EMBODIMENTS

Therefore, there is a need for an approach for providing efficient transmission control signaling, which can co-exist with already developed standards and protocols.

According to one embodiment, a method comprises determining one or more parameters for inclusion as scheduling information. The method also comprises generating control message containing the scheduling information, wherein the control message includes a header field that varies in length depending on the parameters to be included in the control message.

According to another embodiment, an apparatus comprises scheduling logic configured to determine one or more parameters for inclusion as scheduling information, and to generate control message containing the scheduling information, wherein the control message includes a header field that varies in length depending on the parameters to be included in the control message.

According to another embodiment, a method comprises receiving a control message specifying scheduling information that includes one or more parameters, wherein a header field of the control message has a length that varies according to the number of parameters provided in the scheduling information. The method also comprises extracting the one or more parameters.

According to yet another embodiment, an apparatus comprises logic configured to receive a control message specifying scheduling information that includes one or more parameters, wherein a header field of the control message has a length that varies according to the number of parameters provided in the scheduling information, the logic being further configured to extract the one or more parameters.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of transmitting scheduling information, according to various exemplary embodiments of the invention;

FIGS. 2A and 2B are flowcharts of processes for scheduling information signaling, according to various exemplary embodiments;

FIGS. 3A and 3B are, respectively, a diagram of a format for scheduling information, and a Medium Access Control (MAC) header that can specify the scheduling information, according to various embodiments;

FIGS. 4A and 4B are diagrams of formats of a Medium Access Control (MAC) message, according to various embodiments;

FIGS. 5A and 5B are tables of various exemplary signaling approaches for conveying scheduling information, according to various embodiments;

FIGS. 6A-6D are diagrams of communication systems having exemplary long-term evolution (LTE) architectures, in which the user equipment (UE) and the base station of FIG. 1 can operate, according to various exemplary embodiments of the invention;

FIG. 7 is a diagram of hardware that can be used to implement an embodiment of the invention; and

FIG. 8 is a diagram of exemplary components of a user terminal configured to operate in the systems of FIGS. 6A-6D, according to an embodiment of the invention.

### DESCRIPTION OF PREFERRED EMBODIMENT

An apparatus, method, and software for signaling scheduling information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless network compliant with the Third Generation Partnership Project (3GPP) Long Term Evolution (LTE) or EUTRAN (Enhanced UMTS (Universal Mobile Telecommunications System) Terrestrial Radio Access Network)) architecture, it is recognized by one of ordinary skill in the art that the embodiments of the inventions have applicability to any type of communication system (e.g., WiMAX (Worldwide Interoperability for Microwave Access)) and equivalent functional capabilities.

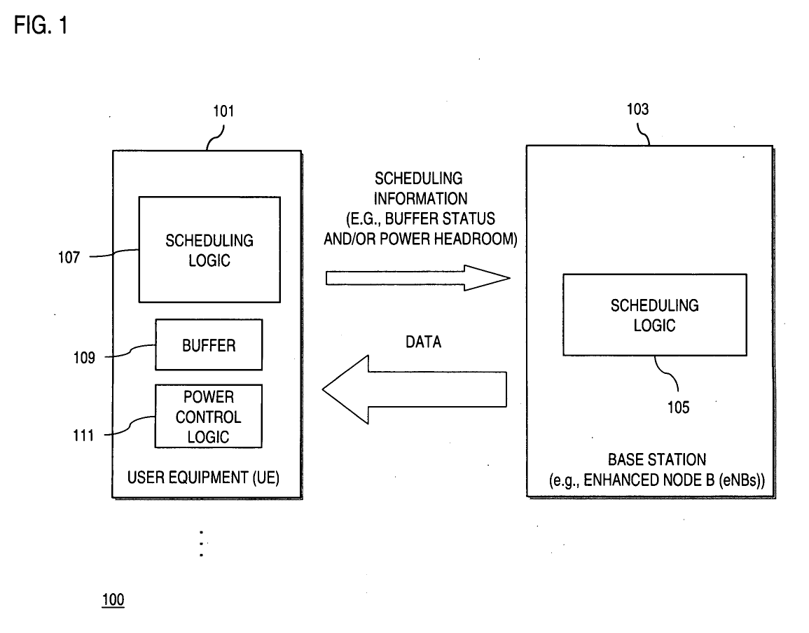

FIG. 1 is a diagram of a communication system capable of providing efficient resource allocation signaling, according to various exemplary embodiments. As shown in FIG. 1, a communication system 100 (e.g., wireless network) includes one or more user equipment (UEs) 101 communicate with a base station 103, which is part of an access network (e.g., 3GPP LTE (or E-UTRAN), etc.) (not shown). According to certain embodiments, the system 100 provides for scheduling information (e.g., uplink) to convey buffer status information (e.g., buffers status report (BSR) and/or power information (e.g., power headroom (PH)). Specifically, a flexible and low-overhead scheme defines “concatenations” of scheduling information with fix-sized control elements and utilizes an identifier field (e.g., Logical Channel Identifier (LCID)) in the header of a control message. Alternatively, other fields (e.g., control type field) can be employed.

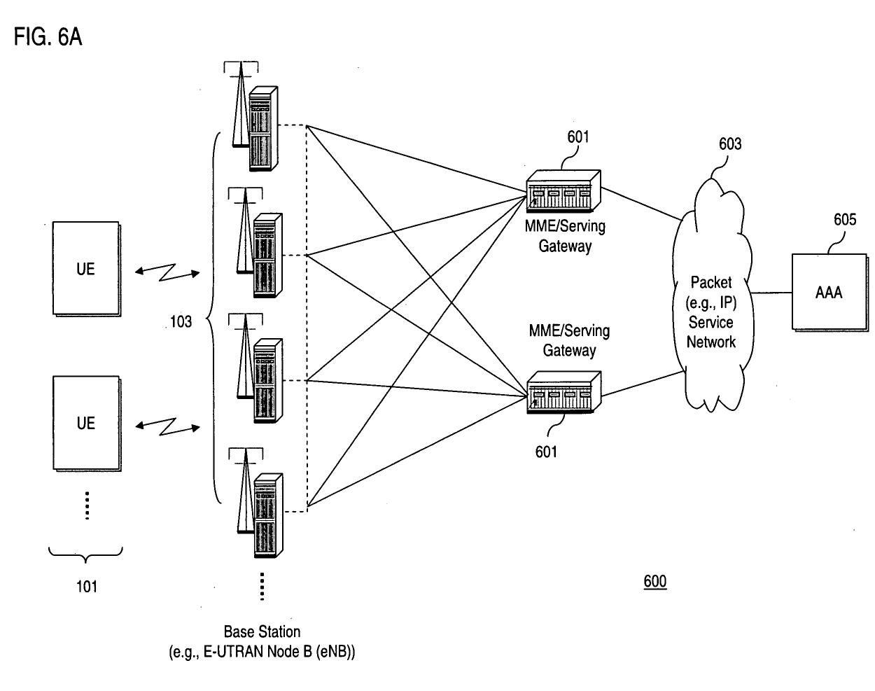

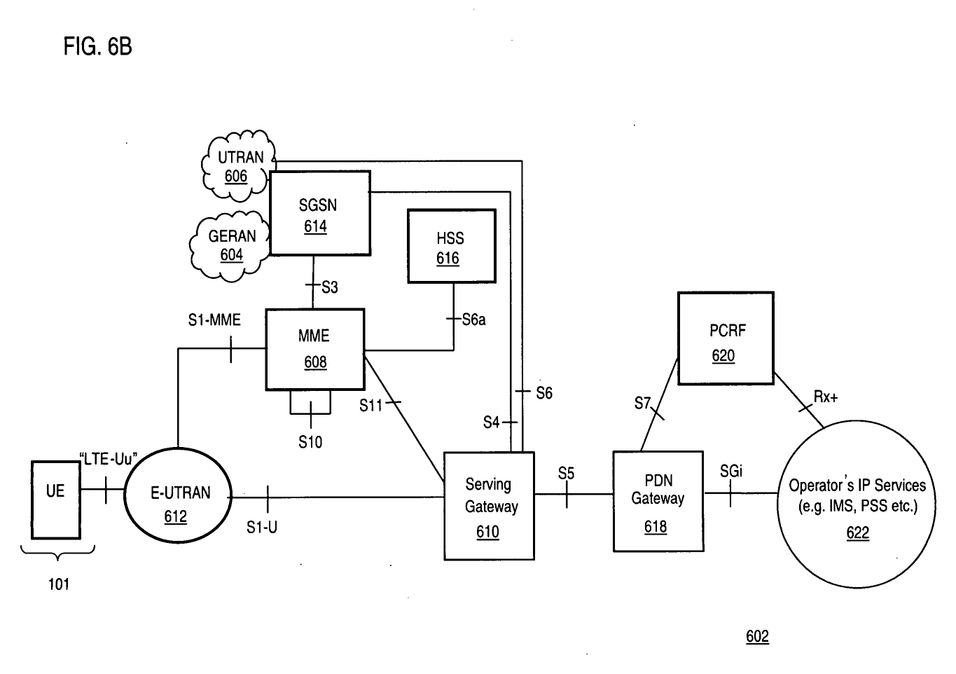

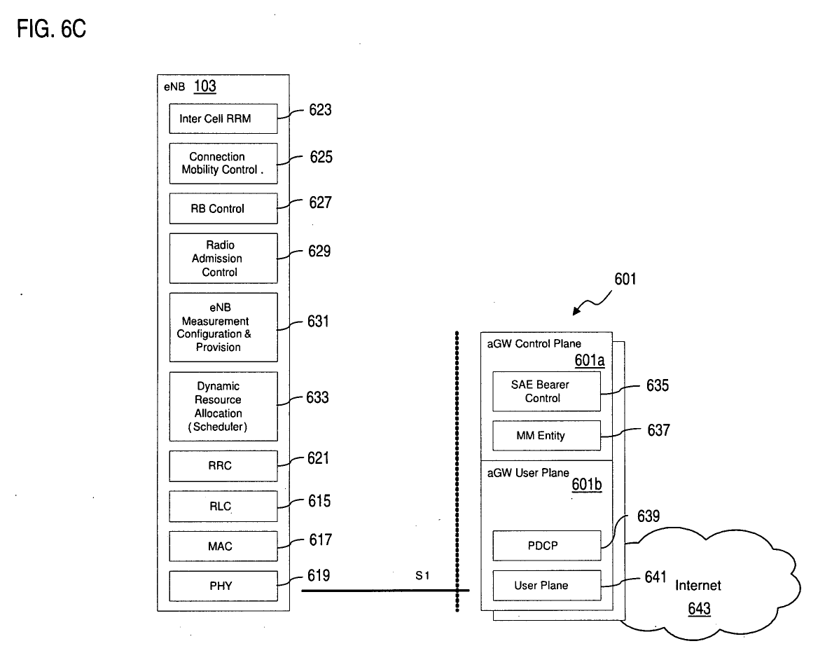

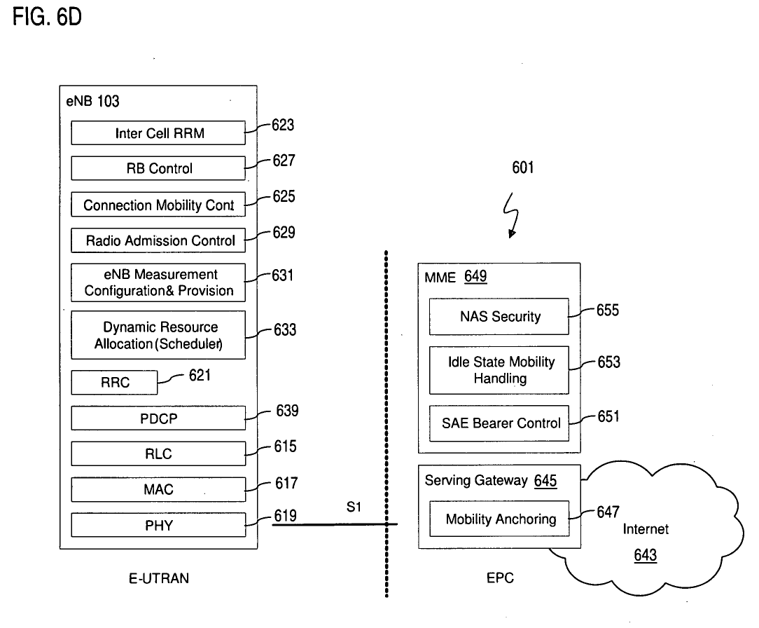

For example, under the 3GPP LTE architecture (as shown in FIGS. 6A-6D), the base station 103 is denoted as an enhanced Node B (eNB). The UE 101 can be any type of mobile stations, such as handsets, terminals, stations, units, devices, multimedia tablets, Internet nodes, communicators, Personal Digital Assistants (PDAs) or any type of interface to the user (such as “wearable” circuitry, etc.). The UE 101 may be a fixed terminal, a mobile terminal, or a portable terminal.

The base station 103 employs a transceiver (not shown) to exchange information with the UE 101 via one or more antennas, which transmit and receive electromagnetic signals. For instance, the base station 103 may utilize a Multiple Input Multiple Output (MIMO) antenna system for supporting the parallel transmission of independent data streams to achieve high data rates with the UE 101. The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access) with cyclic prefix for the uplink (UL) transmission scheme. SC-FDMA can also be realized using a DFT-S-OFDM principle, which is detailed in 3GGP TR 25.814, entitled “Physical Layer Aspects for Evolved UTRA,” v.1.5.0, May 2006 (which is incorporated herein by reference in its entirety). SC-FDMA, also referred to as Multi-User-SC-FDMA, allows multiple users to transmit simultaneously on different sub-bands.

The base station 103 provides scheduling logic 105 to grant resources for a communication link with the UE 101. The communication link, in this example, can be either a downlink, which supports traffic from the network to the user, or an uplink for transmission of data from the UE 101 to the BS 103. In the LTE, the BS 103 maintains tight control of the transmission resources. That is, the BS 103 will, in a controlled manner, provide resources for both uplink and downlink transmissions. Typically, these are given on (1) a time-by-time basis (one grant per transmission), or (2) as semi-persistent allocations/grants, where the resources are given for a longer time period. On the user (or subscriber) side, the UE 101 utilizes a scheduling logic 107 for scheduling transmission of information stored within a transmission buffer 109.

In this example, the allocated resources involve physical resource blocks (PRB), which correspond to OFDM symbols, to provide communication between the UE 101 and the base station 103. That is, the OFDM symbols are organized into a number of physical resource blocks (PRB) that includes consecutive sub-carriers for corresponding consecutive OFDM symbols. To indicate which physical resource blocks (or sub-carrier) are allocated to the UE 101, two exemplary schemes include: (1) bit mapping, and (2) (start, length) by using several bits indicating the start and the length of an allocation block. This signaling of the start and the length will typically use joint coding (i.e., they are signaled using one code word, which contains the information for both parts).

To ensure reliable data transmission, the system 100 of FIG. 1, in certain embodiments, uses concatenation of Forward Error Correction (FEC) coding and an Automatic Repeat Request (ARQ) protocol commonly known as Hybrid ARQ (HARQ). Automatic Repeat Request (ARQ) is an error detection mechanism using error detection logic (not shown). This mechanism permits the receiver to indicate to the transmitter that a packet or sub-packet has been received incorrectly, and thus, the receiver can request the transmitter to resend the particular packet(s). This can be accomplished with a Stop and Wait (SAW) procedure, in which the transmitter waits for a response from the receiver before sending or resending packets. The erroneous packets are used in conjunction with retransmitted packets.

As shown, the UE 103 includes scheduling logic 107 to provide transmission of uplink scheduling information (e.g., buffer status, power headroom reports, and etc.) from the UE 101 to support uplink packet scheduling in the eNB 103. A buffer 109 within the UE 101 stores information that is to be transmitted to the eNB 103. In an exemplary embodiment, the scheduling information is contained in a Medium Access Control (MAC) control message and specifies power headroom information and/or buffer status. The UE power headroom information indicates, for example, the ratio between the maximum allowed UE transmit power and the physical uplink shared channel (PUSCH) power. Such power information can be generated from power control logic 111.

In E-UTRAN transmission of scheduling information (e.g. buffer status and power headroom) is crucial for optimization of radio resource management in the uplink. On the other hand, scheduling information is overhead, and therefore its transmission should be minimized. Based on these considerations, an approach, according to certain embodiments, introduces an efficient mechanism for signaling scheduling information in an E-UTRAN uplink.

To appreciate this approach, it is instructive to examine how scheduling information is provided for in an HSUPA (High Speed Uplink Packet Access) system. The approach standardized for HSUPA (as detailed in 3GPP TS 25.321, MAC protocol specification (Release 7), V7.5.0, June 2007—which is incorporated herein by reference in its entirety) defines a single format for the transmission of scheduling information in the uplink where power headroom and buffer status reports are always transmitted together in the same message. One disadvantage of this approach is that if UE only needs to update e.g. its buffer status, it also needs to transmit power headroom report (only overhead, no additional information).

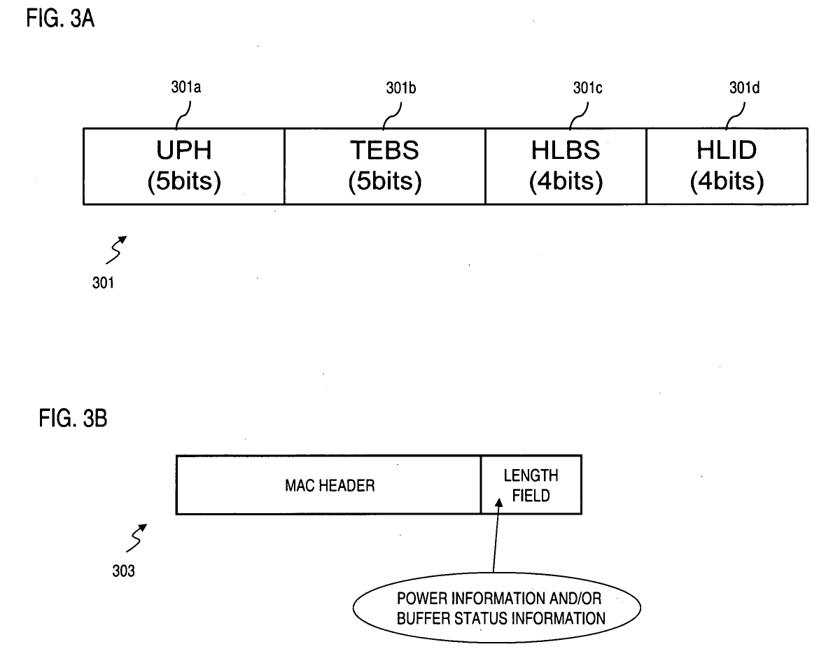

In HSUPA (High Speed Uplink Packet Access), one scheduling information message is specified which carries the following information (shown in FIG. 3): UE Power Headroom (UPH); Total E-DCH Buffer Status (TEBS); Highest priority Logical channel Buffer Status (HLBS); and Highest priority Logical channel ID (HLID). Compared to HSUPA, E-UTRAN uplink is based on an orthogonal multiple access scheme (SC-FDMA). Since under these circumstances the allocation of radio resources to a user that does not have data to transmit directly results in a capacity loss, the design of buffer status reporting scheme becomes quite crucial in E-UTRAN uplink. Moreover, buffer status reports in E-UTRAN uplink should allow differentiation between radio bearers with different Quality of Service (QoS) requirements.

Also, in E-UTRAN due to the use of adaptive transmission bandwidth (i.e., the user transmission bandwidth can be changed between TTIs (Transmission Time Interval)) it is important that the eNB knows with a certain precision the power spectral density used at the UE (to avoid the eNB allocating a transmission bandwidth that cannot be supported, given the maximum UE power capabilities). The need for power headroom reports in E-UTRAN uplink has been recognized by the industry. Additional details of E-UTRAN is provided in 3GPP TS 36.300, E-UTRAN Stage 2, V8.1.0, June 2007; which is incorporated herein by reference in its entirety.

The signaling approach of the system 100 stems from the recognition of the above problems and drawbacks associated with the conventional systems.

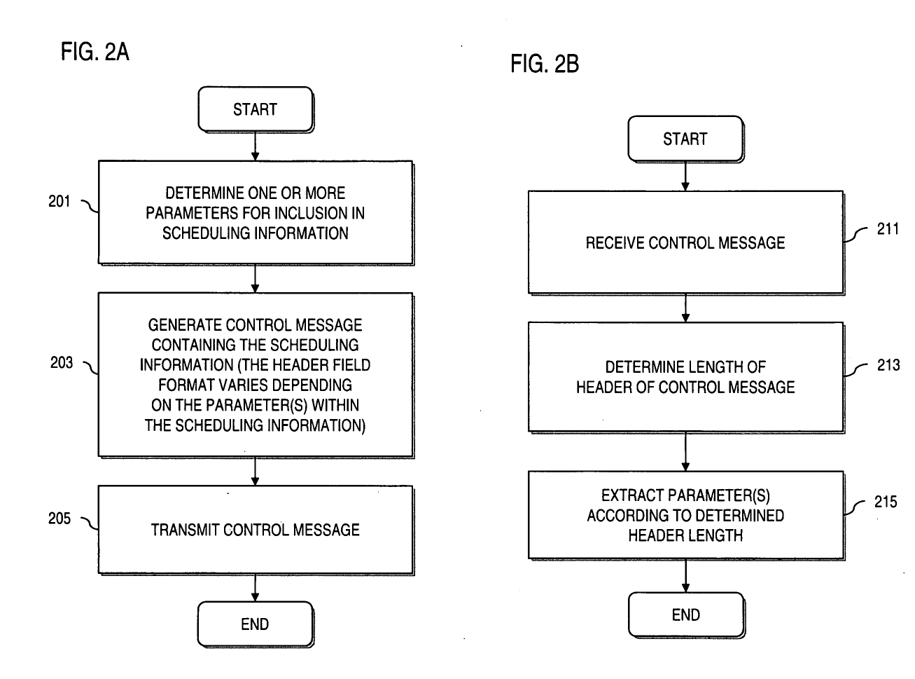

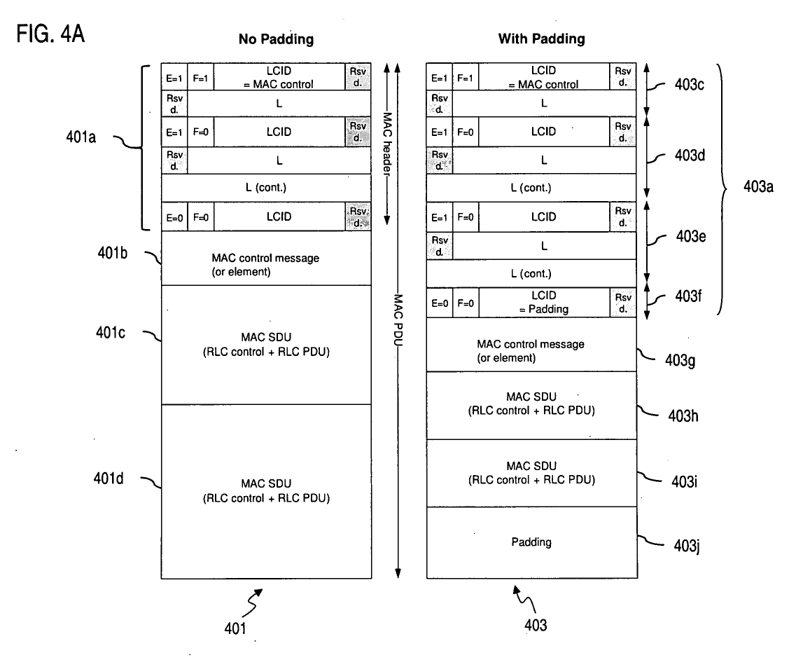

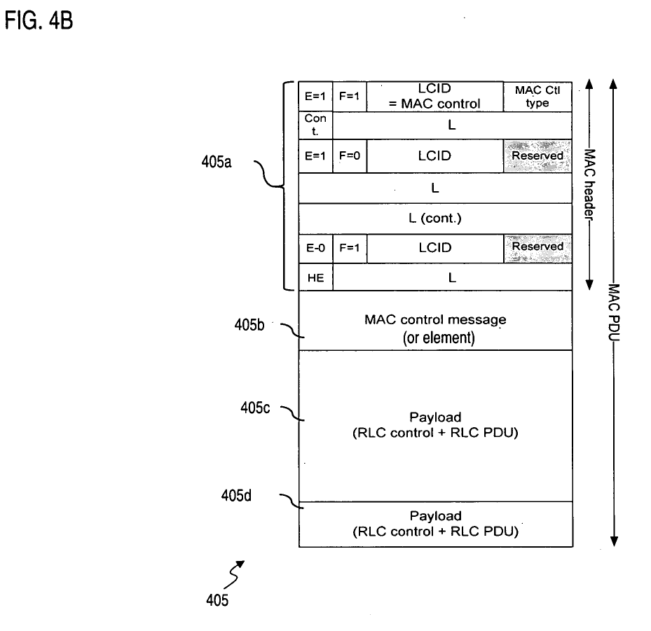

FIGS. 2A and 2B are flowcharts of processes for scheduling information signaling, according to various exemplary embodiments. The process, as shown in FIG. 2A, involves determining one or more parameters for inclusion in scheduling information, per step 201; these parameters can include buffer status (e.g., priority, absolute, etc.) and power headroom, or other control information relating to the corresponding communication link and operation of the transmitter. A control message is then generated, per step 203, to contain the one or more parameters (FIGS. 4A and 4B show such parameters, according to various embodiments). The control message can, for example, be included in the header of a Medium Access Control (MAC) message or a MAC control element. In an exemplary embodiment, a length field can be used to specify the scheduling information. The process then transmits the control message to the base station 103, per step 205.

Per FIG. 2B, on the receiving side, the control message is received by the base station 103, as in step 211, which can then determine the length of the header of the control message and extract the parameter(s) accordingly, respectively in steps 213 and 215.

In the UE 101 for the uplink, all Medium Access Control (MAC) Packet Data Units (PDUs) delivered to the physical layer within one Transmission Time Interval (TTI) are defined as Transport Block Set (TBS), which include one or several Transport Blocks.

FIGS. 3A and 3B are, respectively, a diagram of a format for scheduling information, and a Medium Access Control (MAC) header that can specify the scheduling information, according to various embodiments. With respect to FIG. 3A, a format 301 for providing scheduling information includes, by way of example, the following fields: UE Power Headroom (UPH) field 301a, a Total E-DCH Buffer Status (TEBS) field 301b, a Highest priority Logical channel Buffer Status (HLBS) field 301c, and a Highest priority Logical channel ID (HLID) field 301d. In one embodiment, the UPH field 301a, and the TEBS field 301b are 5 bits in length, while the HLBS field 301c and the HLID field 301d are 4 bits in length.

As shown in FIG. 3B, the scheduling information (such as power headroom, and/or buffer status information) can reside in a header of a MAC message 303. In particular, the information can reside within a length field of the header 303. Consequently, no MAC control element is required.

FIGS. 4A and 4B are diagrams of formats of a Medium Access Control (MAC) message, according to various embodiments. As seen in FIG. 4A, a MAC Protocol Data Unit (PDU) with a first format 401 without padding, and a second format 403 with padding. The MAC PDU 401 includes a MAC PDU header 401a and a MAC PDU payload, which can include MAC control message (or element) 401b, and one or more MAC Service Data Units (SDUs) 401c, 401d.

In the case involving the use of padding, MAC PDU 403 similarly includes a header 403a, which includes a section 403c specifying information for MAC control, sections 403d, 403e corresponding to MAC SDUs, and a section 403f relating to padding. As with the format 401, MAC PDU 403 includes a MAC control element 403g, and one or more MAC Service Data Units (SDUs) 403h, 403i, along with a padding field 403j at the end of the payload.

By way of example, both the MAC header (e.g., 401a, 403a) and the MAC SDU within each of the formats 401, 403 are of variable size. The content and the size of the MAC header 401a, 403a depend on the type of the logical channel, and in some cases none of the parameters in the MAC header are needed. The MAC header further provides for various reserved fields.

The size of the MAC SDU (e.g., 401c, 401d, 403h, 403i) depends on the size of the Radio Link Control (RLC) PDU. The RLC PDU can be defined during the setup procedure. The MAC SDU (e.g., 401c, 401d, 403h, 403i) includes both RLC header and RLC payload.

By way of example, in the MAC PDU header 401a, there is one Logical Channel Identifier (LCID) per MAC SDU. Also, one Length Field (L) is provided per MAC SDU; it is noted that optimization can be considered in case of last MAC SDU 401d. Additionally, within the MAC PDU header 401a, there is one Extension (E) flag and one Format (F) flag present for every MAC SDU. It is noted that there can be a special LCID for MAC control.

Referring back to the processes of FIGS. 2A and 2B, these processes reduce signaling overhead associated with conveying scheduling information in the uplink. In an exemplary embodiment, two types of buffer status reports are considered: (1) absolute buffer status reports (LCID and its corresponding buffer status need be signaled); and (2) priority-based buffer status reports (simplified buffer status for all priority classes need be signaled). According to one embodiment, the LCID field in the MAC header 401a of MAC control elements is used to define different “concatenations” of fix-sized control elements; such as: priority buffer status (e.g., 7 bits); absolute buffer status (e.g., 9 bits); and power headroom report (e.g., 6 bits). In other words, the short or long BSR can be concatenated with the power headroom report.

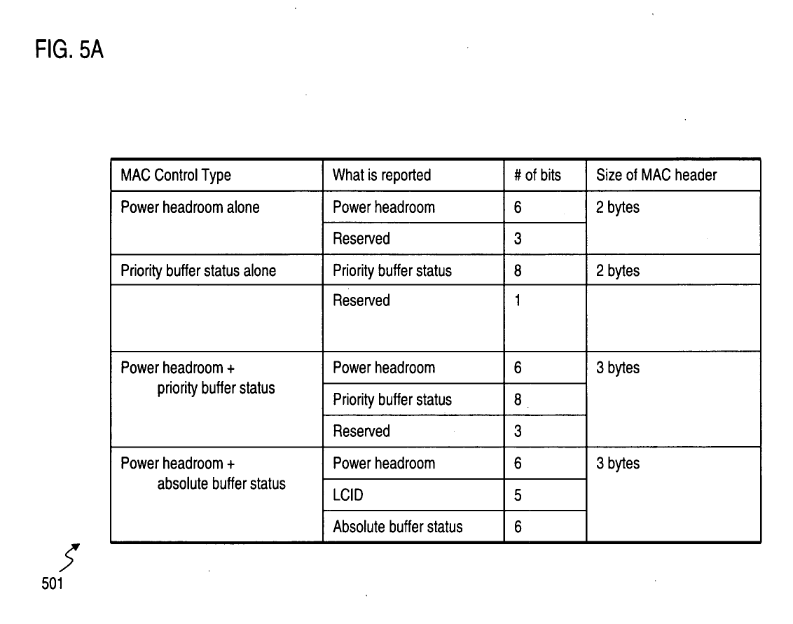

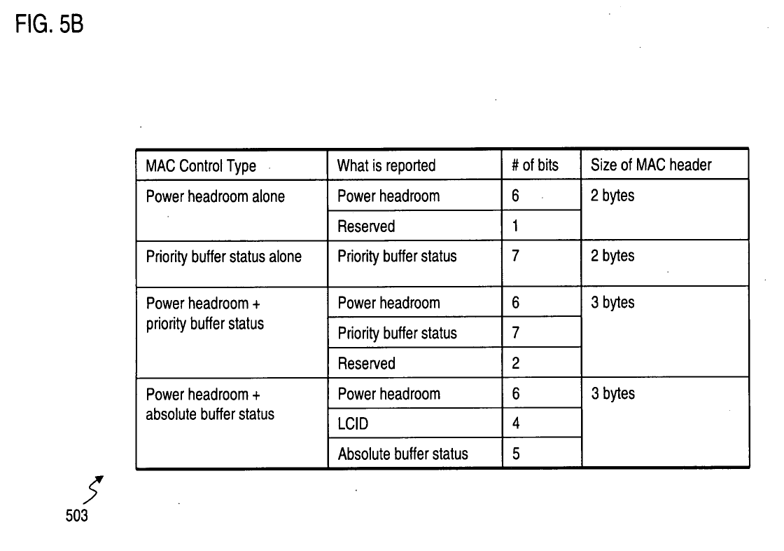

Per FIG. 4B, another format 405 provides for a header 405a with a MAC control type field, a MAC control message (or element) 405b, and payloads 405c, 405d. In one embodiment, the MAC control type field of the header 405a can specify the scheduling information of, e.g., priority buffer status, absolute buffer status, and/or power headroom report. Such information can be configured according to Tables 501 and 503 of FIGS. 5A and 5B. For example, the buffer status information can be in form of a short buffer status report (BSR) for defining a priority buffer status, or a long BSR for an absolute buffer status. These buffer information can be specified in the MAC control element, for instance.

By way of example, the MAC header of messages 401, 403, and 405 utilizes the format of Table 1, below:

TABLE 1

| Field | Length |
|---|---|
| Format flag | 1 bit |
| Extension flag | 1 bit |
| LCID (Logical Channel ID | 4 bits |
| (Identifier)) (=MAC control) | |

Assuming that the length field is not needed for these types of MAC-control messages, the remaining bits can be used in the MAC control header for delivering the information about status reports and power head room, as shown in FIGS. 5A and 5B. That is, Tables 501 and 503 enumerate the information that is transmitted with the MAC-control message. According to certain embodiments, the overhead can be reduced by transmitting buffer status and power headroom reports in the same MAC control element (3 bytes, instead of 2+2=4 bytes). Additionally, the approach of system 100 also allows transmitting the power headroom and buffer status in separate MAC control elements, thus reducing the overhead in case only information on the power headroom (or on the buffer status) is needed (2 bytes instead of 3 bytes).

It is contemplated that the approach can be also used for the case where the length field is used in the MAC header for MAC control element. In such a case, the size of MAC header can be 1-byte larger.

The processes and messaging formats relating to scheduling of resources can thus reduce signaling overhead by conveying such information as buffer status and power headroom.

As described, the communication system 100 of FIG. 1 utilizes an architecture compliant with the UMTS terrestrial radio access network (UTRAN) or Evolved UTRAN (E-UTRAN) in 3GPP, as next described.

FIGS. 6A-6D are diagrams of communication systems having exemplary long-term evolution (LTE) architectures, in which the user equipment (UE) and the base station of FIG. 1 can operate, according to various exemplary embodiments of the invention. By way of example (shown in FIG. 6A), a base station (e.g., destination node) and a user equipment (UE) (e.g., source node) can communicate in system 600 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-FDMA, while downlink utilizes OFDMA.

The communication system 600 is compliant with 3GPP LTE, entitled “Long Term Evolution of the 3GPP Radio Technology” (which is incorporated herein by reference in its entirety). As shown in FIG. 6A, one or more user equipment (UEs) communicate with a network equipment, such as a base station 103, which is part of an access network (e.g., WiMAX (Worldwide Interoperability for Microwave Access), 3GPP LTE (or E-UTRAN), etc.). Under the 3GPP LTE architecture, base station 103 is denoted as an enhanced Node B (eNB).

MME (Mobile Management Entity)/Serving Gateways 601 are connected to the eNBs 103 in a full or partial mesh configuration using tunneling over a packet transport network (e.g., Internet Protocol (IP) network) 603. Exemplary functions of the MME/Serving GW 601 include distribution of paging messages to the eNBs 103, termination of U-plane packets for paging reasons, and switching of U-plane for support of UE mobility. Since the GWs 601 serve as a gateway to external networks, e.g., the Internet or private networks 603, the GWs 601 include an Access, Authorization and Accounting system (AAA) 605 to securely determine the identity and privileges of a user and to track each user's activities. Namely, the MME Serving Gateway 601 is the key control-node for the LTE access-network and is responsible for idle mode UE tracking and paging procedure including retransmissions. Also, the MME 601 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 6B, a communication system 602 supports GERAN (GSM/EDGE radio access) 604, and UTRAN 606 based access networks, E-UTRAN 612 and non-3GPP (not shown) based access networks, and is more fully described in TR 23.882, which is incorporated herein by reference in its entirety. A key feature of this system is the separation of the network entity that performs control-plane functionality (MME 608) from the network entity that performs bearer-plane functionality (Serving Gateway 610) with a well defined open interface between them S11. Since E-UTRAN 612 provides higher bandwidths to enable new services as well as to improve existing ones, separation of MME 608 from Serving Gateway 610 implies that Serving Gateway 610 can be based on a platform optimized for signaling transactions. This scheme enables selection of more cost-effective platforms for, as well as independent scaling of, each of these two elements. Service providers can also select optimized topological locations of Serving Gateways 610 within the network independent of the locations of MMEs 608 in order to reduce optimized bandwidth latencies and avoid concentrated points of failure.

As seen in FIG. 6B, the E-UTRAN (e.g., eNB) 612 interfaces with UE 101 via LTE-Uu. The E-UTRAN 612 supports LTE air interface and includes functions for radio resource control (RRC) functionality corresponding to the control plane MME 608. The E-UTRAN 612 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 608, as a key control node, is responsible for managing mobility UE identifies and security parameters and paging procedure including retransmissions. The MME 608 is involved in the bearer activation/deactivation process and is also responsible for choosing Serving Gateway 610 for the UE 101. MME 608 functions include Non Access Stratum (NAS) signaling and related security. MME 608 checks the authorization of the UE 101 to camp on the service provider's Public Land Mobile Network (PLMN) and enforces UE 101 roaming restrictions. The MME 608 also provides the control plane function for mobility between LTE and 2G/3G access networks with the S3 interface terminating at the MME 608 from the SGSN (Serving GPRS Support Node) 614.

The SGSN 614 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 608 and HSS (Home Subscriber Server) 616. The S10 interface between MMEs 608 provides MME relocation and MME 608 to MME 608 information transfer. The Serving Gateway 610 is the node that terminates the interface towards the E-UTRAN 612 via S1-U.

The S1-U interface provides a per bearer user plane tunneling between the E-UTRAN 612 and Serving Gateway 610. It contains support for path switching during handover between eNBs 103. The S4 interface provides the user plane with related control and mobility support between SGSN 614 and the 3GPP Anchor function of Serving Gateway 610.

The S12 is an interface between UTRAN 606 and Serving Gateway 610. Packet Data Network (PDN) Gateway 618 provides connectivity to the UE 101 to external packet data networks by being the point of exit and entry of traffic for the UE 101. The PDN Gateway 618 performs policy enforcement, packet filtering for each user, charging support, lawful interception and packet screening. Another role of the PDN Gateway 618 is to act as the anchor for mobility between 3GPP and non-3GPP technologies such as WiMax and 3GPP2 (CDMA 1X and EvDO (Evolution Data Only)).

The S7 interface provides transfer of QoS policy and charging rules from PCRF (Policy and Charging Role Function) 620 to Policy and Charging Enforcement Function (PCEF) in the PDN Gateway 618. The SGi interface is the interface between the PDN Gateway and the operator's IP services including packet data network 622. Packet data network 622 may be an operator external public or private packet data network or an intra operator packet data network, e.g., for provision of IMS (IP Multimedia Subsystem) services. Rx+ is the interface between the PCRF and the packet data network 622.

As seen in FIG. 6C, the eNB 103 utilizes an E-UTRA (Evolved Universal Terrestrial Radio Access) (user plane, e.g., RLC (Radio Link Control) 615, MAC (Media Access Control) 617, and PHY (Physical) 619, as well as a control plane (e.g., RRC 621)). The eNB 103 also includes the following functions: Inter Cell RRM (Radio Resource Management) 623, Connection Mobility Control 625, RB (Radio Bearer) Control 627, Radio Admission Control 629, eNB Measurement Configuration and Provision 631, and Dynamic Resource Allocation (Scheduler) 633.

The eNB 103 communicates with the aGW 601 (Access Gateway) via an S1 interface. The aGW 601 includes a User Plane 601a and a Control plane 601b. The control plane 601b provides the following components: SAE (System Architecture Evolution) Bearer Control 635 and MM (Mobile Management) Entity 637. The user plane 601b includes a PDCP (Packet Data Convergence Protocol) 639 and a user plane functions 641. It is noted that the functionality of the aGW 601 can also be provided by a combination of a serving gateway (SGW) and a packet data network (PDN) GW. The aGW 601 can also interface with a packet network, such as the Internet 643.

In an alternative embodiment, as shown in FIG. 6D, the PDCP (Packet Data Convergence Protocol) functionality can reside in the eNB 103 rather than the GW 601. Other than this PDCP capability, the eNB functions of FIG. 6C are also provided in this architecture.

In the system of FIG. 6D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 86.300.

The eNB 103 interfaces via the S1 to the Serving Gateway 645, which includes a Mobility Anchoring function 647. According to this architecture, the MME (Mobility Management Entity) 649 provides SAE (System Architecture Evolution) Bearer Control 651, Idle State Mobility Handling 653, and NAS (Non-Access Stratum) Security 655.

One of ordinary skill in the art would recognize that the processes for signaling scheduling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

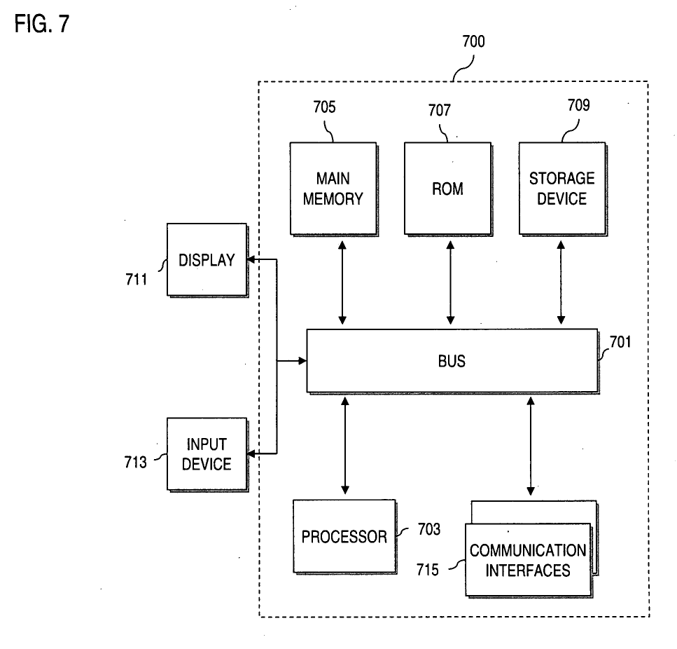

FIG. 7 illustrates exemplary hardware upon which various embodiments of the invention can be implemented. A computing system 700 includes a bus 701 or other communication mechanism for communicating information and a processor 703 coupled to the bus 701 for processing information. The computing system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computing system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computing system 700 may be coupled via the bus 701 to a display 711, such as a liquid crystal display, or active matrix display, for displaying information to a user. An input device 713, such as a keyboard including alphanumeric and other keys, may be coupled to the bus 701 for communicating information and command selections to the processor 703. The input device 713 can include a cursor control, such as a mouse, a trackball, or cursor direction keys, for communicating direction information and command selections to the processor 703 and for controlling cursor movement on the display 711.

According to various embodiments of the invention, the processes described herein can be provided by the computing system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 700 also includes at least one communication interface 715 coupled to bus 701. The communication interface 715 provides a two-way data communication coupling to a network link (not shown). The communication interface 715 sends and receives electrical, electromagnetic, or optical signals that carry digital data streams representing various types of information. Further, the communication interface 715 can include peripheral interface devices, such as a Universal Serial Bus (USB) interface, a PCMCIA (Personal Computer Memory Card International Association) interface, etc.

The processor 703 may execute the transmitted code while being received and/or store the code in the storage device 709, or other non-volatile storage for later execution. In this manner, the computing system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

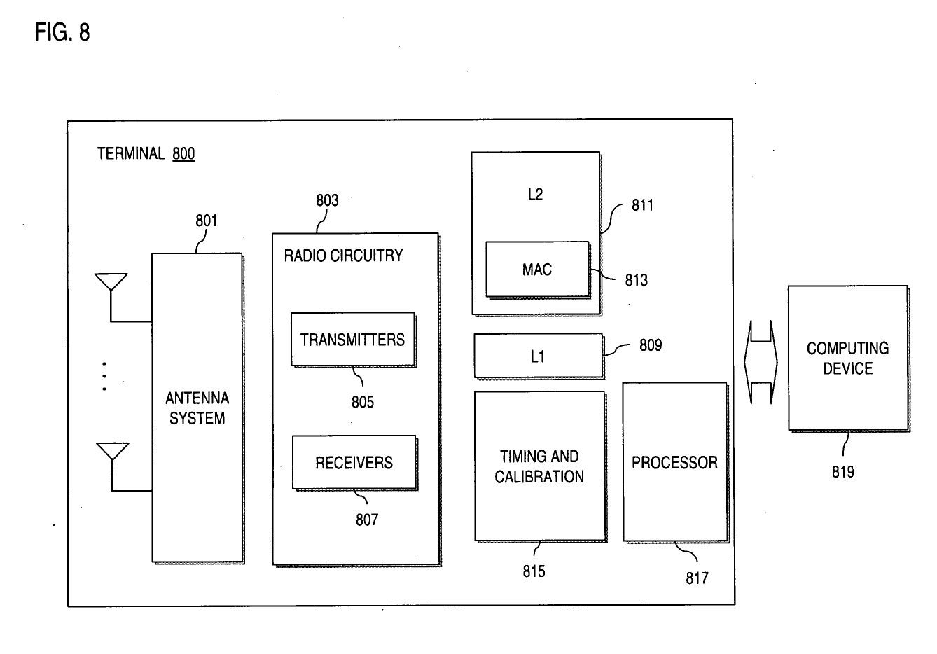

FIG. 8 is a diagram of exemplary components of a user terminal configured to operate in the systems of FIGS. 6A and 6B, according to an embodiment of the invention. A user terminal 800 includes an antenna system 801 (which can utilize multiple antennas) to receive and transmit signals. The antenna system 801 is coupled to radio circuitry 803, which includes multiple transmitters 805 and receivers 807. The radio circuitry encompasses all of the Radio Frequency (RF) circuitry as well as base-band processing circuitry. As shown, layer-1 (L1) and layer-2 (L2) processing are provided by units 809 and 811, respectively. Optionally, layer-3 functions can be provided (not shown). L2 unit 811 can include module 813, which executes all Medium Access Control (MAC) layer functions. A timing and calibration module 815 maintains proper timing by interfacing, for example, an external timing reference (not shown). Additionally, a processor 817 is included. Under this scenario, the user terminal 800 communicates with a computing device 819, which can be a personal computer, work station, a Personal Digital Assistant (PDA), web appliance, cellular phone, etc.

What is claimed is:

1. A method comprising:
determining one or more parameters for inclusion as scheduling information; and
generating message containing the scheduling information in a header field,
wherein the one or more parameters include at least one of buffer status information, power headroom information, or a combination thereof.

2. A method according to claim 1, wherein the message is a Medium Access Control (MAC) layer message.

3. A method according to claim 1, wherein the scheduling information occupies a length field in the header.

4. A method according to claim 1, further comprising:
transmitting the message over an uplink to a base station, and the scheduling information relates to the uplink.

5. A method according to claim 1, wherein the scheduling information is transmitted over a radio communication network compliant with a long term evolution (LTE) architecture.

6. A computer-readable storage medium carrying one or more sequences of one or more instructions which, when executed by one or more processors, cause the one or more processors to perform the method of claim 1.

7. An apparatus comprising:
scheduling logic configured to determine one or more parameters for inclusion as scheduling information, and to generate a message containing the scheduling information in a header field,
wherein the one or more parameters include at least one of buffer status information, power headroom information, or a combination thereof.

8. An apparatus according to claim 7, wherein the message is a Medium Access Control (MAC) layer message.

9. An apparatus according to claim 7, wherein the scheduling information occupies a length field in the header.

10. An apparatus according to claim 7, further comprising:
a transceiver configured to transmit the message over an uplink to a base station, and the scheduling information relates to the uplink.

11. An apparatus according to claim 7, wherein the scheduling information is transmitted over a radio communication network compliant with a long term evolution (LTE) architecture.

12. An apparatus according to claim 7, wherein the apparatus is included in a handset.

13. A method comprising:
receiving a message specifying scheduling information that includes one or more parameters, wherein a header field of the message includes the scheduling information, and the one or more parameters include at least one of buffer status information, power headroom information, or a combination thereof; and
extracting the one or more parameters.

14. A method according to claim 13, wherein the message is a Medium Access Control (MAC) layer message.

15. A method according to claim 13, wherein the scheduling information occupies a length field in the header.

16. A method according to claim 13, wherein the message is received over an uplink, and the scheduling information relates to the uplink.

17. A method according to claim 13, wherein the scheduling information is transmitted over a radio communication network compliant with a long term evolution (LTE) architecture.

18. A computer-readable storage medium carrying one or more sequences of one or more instructions which, when executed by one or more processors, cause the one or more processors to perform the method of claim 13.

19. An apparatus comprising:
logic configured to receive a message specifying scheduling information that includes one or more parameters,
wherein a header field of the message includes the scheduling information, and the one or more parameters include at least one of buffer status information, power headroom information, or a combination thereof, the logic being further configured to extract the one or more parameters.

20. An apparatus according to claim 19, wherein the message is a Medium Access Control (MAC) layer message.

21. An apparatus according to claim 19, wherein the scheduling information occupies a length field in the header.

22. An apparatus according to claim 19, wherein the message is received over an uplink, and the scheduling information relates to the uplink.

23. An apparatus according to claim 19, wherein the scheduling information is transmitted over a radio communication network compliant with a long term evolution (LTE) architecture.
